(19) United States
(12) Patent Application Publication
(10) Pub. No.: US 2025/0360609 A1
(43) Pub. Date: Nov. 27, 2025

(54) Hand-Held Power Tool comprising a Tool Holder

(71) Applicant: Robert Bosch GmbH, Stuttgart (DE)

(72) Inventors: Tobias Herr, Grafenau (DE); Jens Blum, Filderstadt (DE); Marcus Schuller, Dettenhausen (DE); Simon Erbele, Nufringen (DE)

(21) Appl. No.: 19/108,362

(22) PCT Filed: Aug. 4, 2023
(86) PCT No.: PCT/EP2023/071675

§ 371 Date: Mar. 3, 2025

(30) Foreign Application Priority Data
Sep. 7, 2022 (DE) 10 2022 209 284.8

(51) Int. Cl. B25F 5/00; B25B 21/02; B25B 23/00

(52) U.S. Cl. CPC B25F 5/001; B25B 21/02; B25B 23/0035; B25F 5/006

(57) ABSTRACT

A hand-held power tool includes a tool receptacle and a housing in which a drive motor and a gear mechanism are arranged. The gear mechanism is arranged in a gear housing. The tool receptacle has a receiving sleeve which is mounted in the gear housing such that it can rotate via at least one bearing element and is designed to receive an insert tool. The gear housing has a receptacle with an annular collar for receiving the at least one bearing element. A fastening element is provided for fastening the at least one bearing element in the receptacle. The fastening element is fastened to the annular collar and closes the receptacle at least in certain regions on an end face of the gear housing.

### PRIOR ART

The present invention relates to a hand-held power tool with a tool receptacle and a housing, in which a drive motor and a gear mechanism are arranged, the gear mechanism being arranged in a gear housing, the tool receptacle having a receiving sleeve which is mounted in the gear housing such that it can rotate by means of at least one bearing element and is designed to receive an insert tool, and the gear housing having a receptacle with an annular collar for receiving the at least one bearing element.

A hand-held power tool of this kind with a gear mechanism arranged in a gear housing is known from the prior art. A tool receptacle of the hand-held power tool has a receiving sleeve that is mounted in the gear housing so that it can rotate on at least one bearing element. The gear housing has a receptacle with an annular collar for receiving the at least one bearing element.

### DISCLOSURE OF THE INVENTION

The invention relates to a hand-held power tool with a tool receptacle and a housing in which a drive motor and a gear mechanism are arranged, the gear mechanism being arranged in a gear housing, the tool receptacle having a receiving sleeve which is mounted in the gear housing such that it can rotate by means of at least one bearing element and is designed to receive an insert tool, and the gear housing having a receptacle with an annular collar for receiving the at least one bearing element. A fastening element is provided for fastening the at least one bearing element in the receptacle, wherein the fastening element is attached to the annular collar and the receptacle closes at least a region of an end face of the gear housing.

The invention thus makes it possible to provide a hand-held power tool with a tool receptacle in which the fastening element can be used for fastening the at least one bearing element in a stable and robust manner.

The fastening element is preferably designed as a cup-shaped part with a sleeve-shaped base body, on which an annular collar for support on the gear housing and a ring-disk-shaped bottom surface for at least partial closure of the receptacle are formed.

This makes it easy to fasten the at least one bearing element in the receptacle.

A gear cover is preferably arranged on an outer periphery of the gear housing, forming a receptacle facing the annular collar of the fastening element, a spring or damping element being arranged in the receptacle for pretensioning the fastening element on the gear housing.

This ensures that the fastening element is securely and reliably positioned on the gear housing.

According to one embodiment, the at least one bearing element has a bearing width assigned to it in the longitudinal direction of the receiving sleeve, the ring-disk-shaped bottom surface of the fastening element having a wall thickness that is smaller than a quarter of the bearing width and is preferably smaller than a fifth of the bearing width.

This provides a simple way of producing a suitable fastening element.

Preferably, the ring-disk-shaped bottom surface has a wall thickness of less than 2.2 mm.

This provides a compact and stable fastening element.

The fastening element, in particular the sleeve-shaped base body, is preferably fastened to an outer periphery of the annular collar of the receptacle by means of a press fit or a joint fit.

This ensures a robust and stable arrangement of the fastening element on the gear housing.

According to one embodiment, the fastening element is formed integrally with a gear cover arranged on an outer periphery of the gear housing.

This provides a simple and compact fastening element.

Preferably, one end face of the gear cover forms the fastening element, with the end face having a ring-disk-shaped fastening section.

This makes it easy to design the fastening element.

Preferably, the ring-disk-shaped bottom surface and the ring-disk-shaped fastening section each have a reach-through opening, and a diameter of the reach-through opening is smaller than an outer diameter of the at least one bearing element.

This makes it easy to fasten the at least one bearing element in the axial direction.

The fastening element or the gear cover is preferably made of plastic, sheet metal and/or aluminum.

This provides a simple and cost-effective fastening element and gear cover.

### BRIEF DESCRIPTION OF THE DRAWINGS

The invention is explained in more detail in the following description with reference to the exemplary embodiments shown in the drawings. The figures show:

FIG. 1 a schematic view of a hand-held power tool with a gear mechanism arranged in a gear housing.

FIG. 2 a longitudinal section through the gear housing with the gear mechanism of FIG. 1, with a bearing of a tool receptacle and a fastening element.

FIG. 3 an enlarged section of the longitudinal section through the bearing of the tool receptacle and the fastening element of FIG. 2,

FIG. 4 an exploded view of the gear housing with the fastening element and a housing cover from FIG. 2 and FIG. 3,

FIG. 5 a perspective view of the fastening element of FIG. 2 through FIG. 4,

FIG. 6 a perspective view of the gear cover from FIG. 2 through FIG. 4, and

FIG. 7 a longitudinal section through the gear hosing with the gear mechanism of FIG. 1, showing a bearing of a tool receptacle and an alternative fastening element.

### DESCRIPTION OF THE EXEMPLARY EMBODIMENTS

Elements having the same or a comparable function are provided with the same reference signs in the figures and are described in detail only once.

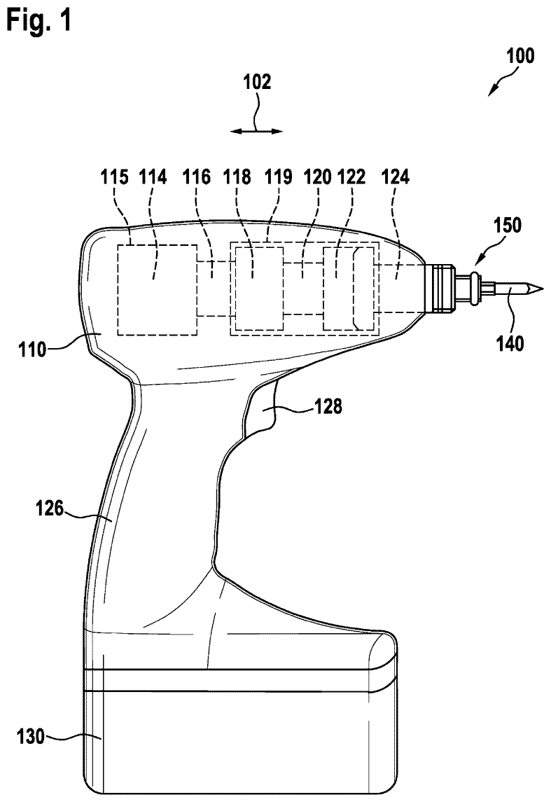

FIG. 1 shows a hand-held power tool (100) equipped with a tool receptacle (150), which has a housing (110) with a handle (126). According to the embodiment shown, the hand-held power tool 100 is mechanically and electrically connectable to a battery pack 130 for electricity supply apart from an electrical network.

Illustratively, a drive motor 114 supplied with electricity by the battery pack 130 and a gear mechanism 118 are arranged within the housing 110. The drive motor 114 is, e.g., operable (i.e., can be switched on and off) via a hand switch 128, and can be any desired type of motor, e.g., an electronically commutated motor or a DC motor. Preferably, the drive motor 114 can be controlled or regulated electronically in such a way that both a reversing operation and specifications with regard to a desired rotational speed can be realized. The functionality and construction of a suitable drive motor are sufficiently known from the prior art, so a detailed description is omitted herein for the purpose of brevity in the description.

The drive motor 114 is connected to the gear mechanism 118 via an associated motor shaft 116, which converts rotation of the motor shaft 116 into rotation of an output shaft 124. This conversion is preferably carried out in such a way that the output shaft 124 rotates relative to the motor shaft 116 with increased torque but reduced rotational speed. The drive motor 114 is illustratively arranged within a motor housing 115. The gear mechanism 118 is arranged within a gear housing 119. The gear housing 119 and the motor housing 115 are arranged in the housing 110 as examples.

According to one embodiment, a mechanical striking mechanism 122 is provided. The drive motor 114 is connected to the gear mechanism 118 via the motor shaft 116 in such a way that a rotation of the motor shaft 116 is converted into a rotation of an intermediate shaft 120 provided between the gear mechanism 118 and the striking mechanism 122. The mechanical striking mechanism 122 and/or the gear mechanism 118 are arranged in a common gear housing 119 for illustrative purposes. Alternatively, the mechanical striking mechanism 122 can also be arranged in a separate striking mechanism housing.

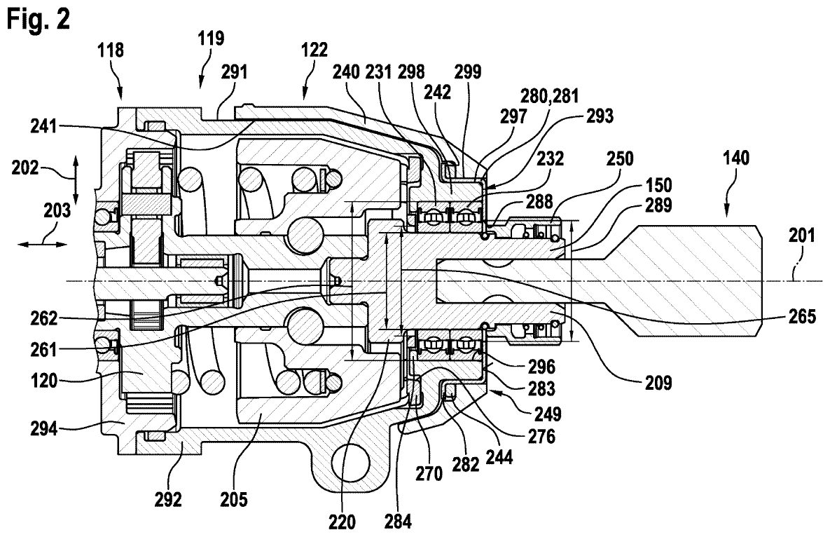

The mechanical striking mechanism 122 connected to the intermediate shaft 120 is, for example, a rotary or oscillating-rotary striking mechanism that generates high-intensity oscillatory rotary impulses and transmits them to an output shaft 124, e.g. an output spindle. In the following, the mechanical striking mechanism is referred to as “mechanical rotary striking mechanism 122”. In particular, the 122 mechanical rotary striking mechanism is designed to drive the tool receptacle 150. The mechanical rotary striking mechanism 122 has a spring-loaded impact body (205 in FIG. 2) that is coupled to the intermediate shaft 120 and is mounted on the intermediate shaft 120 so that it can slide in the axial direction 102 of the gear mechanism 118.

Provided on the output shaft 124 is a tool receptacle 150, which is preferably designed to receive insert tools and is preferably connectable to an insert tool 140 having an outward multi-face coupling. The insert tool 140 is, e.g., designed as a screwdriver bit having an outward multi-face coupling, illustratively an octagonal coupling. Such a screwdriver bit is sufficiently known from the prior art, so a detailed description is omitted herein for the purpose of brevity in the description. Further provided is a locking unit 190 for locking and unlocking the insert tool 140, which is illustratively arranged in the tool receptacle 150.

FIG. 2 shows the gear mechanism 118 arranged in the gear housing 119 of FIG. 1, as well as the optional mechanical rotary striking mechanism 122 with the intermediate shaft 120 of FIG. 1. By way of illustration, the optional mechanical rotary striking mechanism 122 has a spring-loaded impact body 205 and an anvil 220 that can be impacted by the impact body 205. The anvil 220 is preferably assigned to the tool receptacle 150, in particular to a receiving sleeve 209 assigned to the tool receptacle 150. Preferably, the anvil 220 is formed in one piece with the receiving sleeve 209. In this case, the anvil 220 is oriented transversely illustratively, in particular essentially perpendicular to the receiving sleeve 209.

The mechanical rotary striking mechanism 122 generates sudden high-intensity rotary impulses and transfers them to the output shaft 124 and, via the anvil 220, to the receiving sleeve 209 of the tool receptacle 150. The spring-loaded impact body 205 is mounted so that it can be displaced in the axial direction 102 of FIG. 1 of the gear mechanism 118. Such a mechanical rotary striking mechanism 122 is sufficiently known from the prior art, so that a detailed description is dispensed with here for the sake of conciseness.

The receiving sleeve 209 is designed to receive the insert tool 140. The receiving sleeve 209 is preferably radially mounted within a bearing element 231, 232 fastened in the gear housing 119, such that it can rotate and slide axially. Illustratively, the gear housing 119 comprises two sections 292, 294, which are connected to one another. The section 294 is preferably designed as a lid that is attached to the section 292.

Furthermore, FIG. 2 shows the insert tool 140, which is illustratively designed as a bit tool and is locked in the tool receptacle 150 or the receiving sleeve 209. The insert tool 140 can be unlocked by moving an actuating sleeve 250 of an undisclosed locking unit, preferably axially.

The tool receptacle 150 illustratively comprises an axial longitudinal extension 203. It is noted that, in the context of the present invention, the term “axial” is understood to mean a direction along the longitudinal extension 203 of the tool receptacle 150. Furthermore, the term “radial” is understood to mean a direction approximately perpendicular to the longitudinal extension 203 of the tool receptacle 150. The radial direction 202 is therefore oriented approximately perpendicular to the axial direction 102 from FIG. 1 of the gear mechanism 118, or rather along the longitudinal extension 203 of the tool receptacle 150. Furthermore, the axial direction 102 is essentially parallel to the longitudinal extension 203 of the tool receptacle 150 or parallel to an axis of rotation 201 of the tool receptacle 150.

Preferably, the gear housing 119, in particular the section 292, has a receiver 296 with an annular collar 298 for receiving the at least one bearing element 231, 232. Preferably, the gear housing 119, in particular the section 292, forms the receptacle 296. In this case, at least one bearing element 231, 232 is preferably arranged radially between the gear housing 119 and the receiving sleeve 209. Two bearing elements 231, 232 are arranged in the receptacle 296 of the gear housing 119. The two illustrative bearing elements 231, 232 are in axial contact along the axis of rotation 201 of the tool receptacle 150, i.e. they are in contact with each other. According to one embodiment, the bearing elements 231, 232 are designed as rolling bearings, in particular ball bearings.

A buffer ring 270 is preferably provided, which is preferably arranged in the gear housing 119 and c is designed to dampen impact energy transmitted by the impact body 205 to the gear housing 119. The buffer ring 270 faces the impact body 205 and is preferably arranged at least in some areas axially between the anvil 220 and the bearing elements 231, 232.

According to the invention, a fastening element 280 is provided for axially fastening the at least one bearing element 231, 232 in the receptacle 296. In this case, the fastening element 280 is attached to the annular collar 298 and closes, preferably at least in some areas, the receptacle 296 on an end face 293 of the gear housing 119 that is facing away from the hand-held power tool 100 of FIG. 1. The end face 293 is preferably arranged facing the actuating sleeve 250.

According to one embodiment, the fastening element 280 is designed as a pot-shaped part with a sleeve-shaped base body 281. The sleeve-shaped base body 281 preferably has an annular collar 282 for support on the gear housing 119 and a ring-disk-shaped bottom surface 283 for closing the receptacle 296, at least in some areas.

A gear cover 240 is preferably arranged on an outer periphery 291 of the gear housing 119. In this case, an inner side 241 of the gear cover 240 facing the gear housing 119 or the section 292 is arranged on the outer periphery 291 of the gear housing 119 or the section 292. One end face 249 of the gear cover 240 and the ring-disk-shaped bottom surface 283 are preferably congruent in the axial direction 203, forming a common surface.

Preferably, the gear cover 240 forms a receptacle 242 facing the annular collar 282 of the fastening element 280. In the receptacle 242, a spring or damping element 244 is preferably arranged for pretensioning the fastening element 280 on the gear housing 119. Preferably, the annular collar 282 is axially arranged between the section 292 of the gear housing 119 and the spring or damping element 244. Furthermore, an outer periphery 299 of the sleeve-shaped base body 281 of the fastening element 280 is preferably arranged on the inside 241 of the gear cover 240. In particular, the sleeve-shaped base body 281 is preferably arranged radially between the gear cover 240 and the annular collar 298 of the receptacle 296. Preferably, the fastening element 280, in particular the sleeve-shaped base body 281, is fastened to an outer periphery 297 of the annular collar 298 of the receptacle 296 by means of an interference fit or a press fit.

The fastening element 280 or the gear cover 240 preferably has plastic, sheet metal and/or aluminum. In one embodiment of the fastening element 280, the fastening element 280 made of sheet metal can simultaneously serve as a cooling element. In this case, the fastening element 280 can be designed as a deep-drawn part, according to one embodiment.

Preferably, the ring-disk-shaped bottom surface 283 has a reach-through opening 288 with a diameter 289. The diameter 289 is preferably smaller than the outer diameter 262 of the at least one bearing element 231, 232. Furthermore, the diameter 289 of the reach-through opening 288 is preferably larger than or equal to an inner diameter 261 of the at least one bearing element 231, 232.

By way of illustration, radial elevations 284 of the gear housing 119 form an axial support for the at least one bearing element 231, 232 that can be arranged in the receptacle 296, whereby a displacement of the at least one bearing element 231, 232 in the axial direction 102 of the gear mechanism 118 with respect to the drive motor 114 or to the left in the illustration. To this end, the elevation 284 closes the receptacle 296 in sections at its radially outer region. In one embodiment, the elevations 284 and corresponding recesses 276 of the buffer ring 270 form an anti-rotation device for the buffer ring 270.

The buffer ring 270 preferably has an inner diameter 265. Preferably, the inner diameter 265 is smaller than the outer diameter 262 of the bearing element 231, 232. In addition, the inner diameter 265 of the buffer ring 270 is preferably greater than or equal to the inner diameter 261 of the bearing element 231, 232. Thus, the buffer ring 270 can also axially support the bearing element 231 in the area of its inner diameter 265.

Preferably, the two illustrative bearing elements 231, 232 are arranged axially between the elevation 284 and/or the buffer ring 270 and the ring-disk-shaped bottom surface 283 of the fastening element 280. As a result, the forces acting on the bearing elements 231, 232 are directed into the housing 110 of the hand-held power tool 100 of FIG. 1. It should be noted that the hand-held power tool 100 or the optional rotary striking mechanism 122 may also be designed without a buffer ring 270.

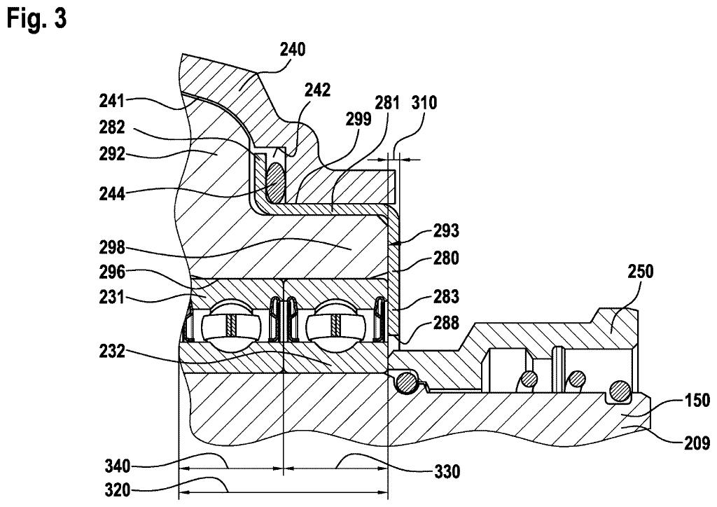

FIG. 3 shows the arrangement of the fastening element 280 on section 292 of the gear housing 119 from FIG. 2. In this case, FIG. 3 illustrates a wall thickness 310 of the ring-disk-shaped bottom surface 283 of the fastening element 280. The wall thickness 310 is preferably less than 2.2 mm, preferably less than 1 mm.

Furthermore, the at least one bearing element 231, 232 in the longitudinal direction of the receiving sleeve 209, or in the axial direction 203, illustratively has an associated bearing width 320. The preferred wall thickness 310 is less than a quarter of the bearing width 320. The wall thickness 310 is particularly preferred to be less than one fifth of the bearing width 320.

In the design shown, with the two bearing elements 231, 232, each bearing element 231, 232 has an individual bearing width 330, 340. The bearing width 320 is made up of the two individual bearing widths 330 and 340. It should be noted that more than two bearing elements 231, 232 may also be provided.

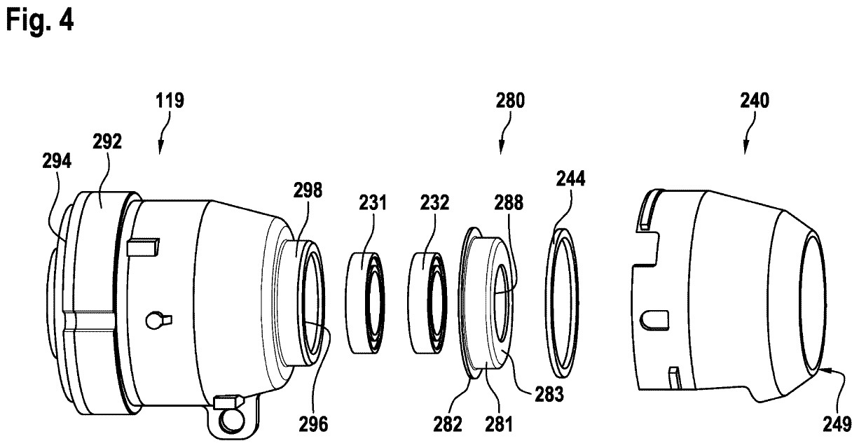

FIG. 4 shows the gear housing 119, the receptacle 296 with the annular collar 298 for receiving the bearing elements 231, 232, the fastening element 280, the spring or damping element 244 for pretensioning the fastening element 280 on the gear housing 119, and the gear cover 240 of FIG. 2 and FIG. 3 for the purpose of illustrating an exemplary assembly in an exploded view.

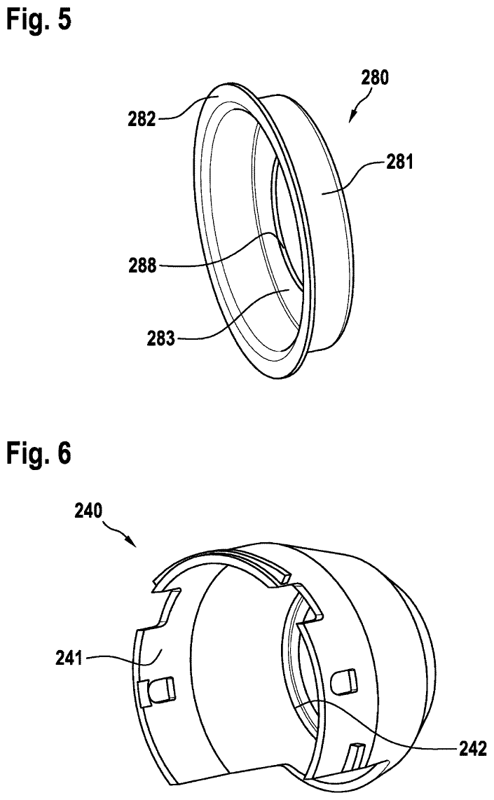

FIG. 5 shows the fastening element 280 from FIG. 2 through FIG. 4. In this context, FIG. 5 illustrates the sleeve-shaped base body 281 with the annular collar 282 for support on the gear housing 119 of FIG. 2 through FIG. 4, as well as the ring-disk-shaped bottom surface 283 for at least partial closure of the receptacle 296 of the gear housing 119.

FIG. 6 shows the gear cover 240 of the gear housing 119 from FIG. 2 through FIG. 4. In this context, FIG. 6 illustrates the receptacle 242 formed on the inside 241 of the gear cover 240 for receiving the spring or damping element 244 of FIG. 2 through FIG. 4.

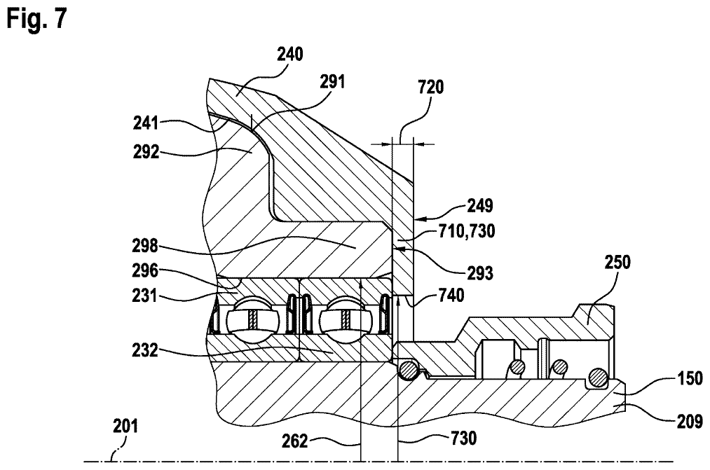

FIG. 7 shows the arrangement of an alternative fastening element 780 on section 292 of the gear housing 119 from FIG. 2 through FIG. 4. The fastening element 780 is preferably designed in one piece with the gear cover 240 arranged on the outer periphery 291 of the gear housing 119. In this case, the fastening element 780 is designed illustratively on the end face 249 of the gear cover 240. The end face 249 has a ring-disk-shaped fastening section 710. Analogous to the fastening element 280 of FIG. 2 through FIG. 5, the fastening section 710 has a wall thickness 720 which preferably has at least 2.4 mm.

Preferably, the ring-disk-shaped fastening section 710 has a reach-through opening 740. A diameter 730 of the reach-through opening 740 is preferably smaller than the outer diameter 262 of the bearing elements 231, 232. Furthermore, the diameter 730 of the reach-through opening 740 is greater than or equal to the inner diameter 261 of the bearing elements 231, 232.

According to the embodiment shown in FIG. 7, no spring or damping element 244 of FIG. 2 through FIG. 4 is required, therefore the inner side 241 of the gear cover 240 rests against the outer periphery 291 of the gear housing 119 or the section 292.

1. A hand-held power tool, comprising:
a tool receptacle;
a housing;
a drive motor arranged in the housing;
a gear mechanism arranged in the housing;
a gear housing in which the gear mechanism is also arranged; and
a fastening element,
wherein the tool receptacle has a receiving sleeve which is (i) mounted in the gear housing so as to be rotatable via at least one bearing element, and (ii) designed to receive an insert tool,
wherein the gear housing has a receptacle with an annular collar configured to receive the at least one bearing element,
wherein the fastening element is configured to fasten the at least one bearing element in the receptacle, and
wherein the fastening element is (i) fastened to the annular collar, and (ii) closes the receptacle on one end face of the gear housing at least in certain regions.

2. The hand-held power tool according to claim 1, wherein the fastening element is designed as a pot-shaped part having a sleeve-shaped base body, on which an annular collar for support on the gear housing and a ring-disk-shaped bottom surface for closing the receptacle at least in some regions are formed.

3. The hand-held power tool according to claim 2, further comprising:
a gear cover arranged on an outer periphery of the gear housing, the gear cover being configured to form a receptacle facing the annular collar of the fastening element, and
a spring or damping element is (i) arranged in the receptacle and (ii) configured to pretension the fastening element on the gear housing.

4. The hand-held power tool according to claim 2, wherein:
the at least one bearing element has an associated bearing width in the longitudinal direction of the receiving sleeve, and
the ring-disk-shaped bottom surface of the fastening element has a wall thickness which is smaller than a quarter of the bearing width.

5. The hand-held power tool according to claim 2, wherein the ring-disk-shaped bottom surface of the fastening element has a wall thickness which is less than 2.2 mm.

6. The hand-held power tool according to claim 2, wherein the sleeve-shaped base body is fastened on an outer periphery of the annular collar of the receptacle by way of an interference fit or an assembly fit.

7. The hand-held power tool according to claim 1, further comprising a gear cover arranged on an outer periphery of the gear housing,
wherein the fastening element is formed integrally with the gear cover.

8. The hand-held power tool according to claim 7, wherein:
one end face of the gear cover is configured to form the fastening element, and
the end face has a ring-disk-shaped fastening section.

9. The hand-held power tool according to claim 2, wherein:
the ring-disk-shaped bottom surface and the ring-disk-shaped fastening section each have a reach-through opening, and
a diameter of the reach-through opening is smaller than an outer diameter of the at least one bearing element.

10. The hand-held power tool according to claim 3, wherein the fastening element or the gear cover comprises plastic, sheet metal and/or aluminum.

11. The hand-held power tool according to claim 4 wherein the wall thickness is smaller than a fifth of the bearing width.
